(19) United States
(12) Patent Application Publication
(10) Pub. No.: US 2006/0112609 A1
(43) Pub. Date: Jun. 1, 2006

(54) Portable Livewell

(76) Inventor: Christopher Joey Lee, Odessa, TX (US)

Correspondence Address: TIM COOK, P.O. BOX 10107, LIBERTY, TX, 77575, US

(21) Appl. No.: 11/160,969

(22) Filed: Jul. 18, 2005

Related U.S. Application Data
(60) Provisional application No. 60/632,400, filed on Dec. 1, 2004.

(51) Int. Cl. A01K 97/20; A01K 97/05

(52) U.S. Cl. 43/57; 43/55

(57) ABSTRACT

A portable livewell comprises a lined bag providing a volume adequate to carry a fish of an anticipated size and weight. Preferably, the bag retains a quantity of the water from which the fish was harvested while being moved. This allows the fish to be returned to its environment in relatively good health. The water is circulated by a self-contained aeration system, including a battery-powered pump.

This application claims the benefit of U.S. Provisional Patent Application Ser. No. 60/632,400 filed Dec. 1, 2004.

### FIELD OF THE INVENTION

The present invention relates generally to the field of livewells which keep fish and bait alive and, more particularly, to a portable livewell in which a game fish may be kept alive until released back into its natural environment.

### BACKGROUND OF THE INVENTION

Fishing is a popular activity enjoyed by millions of people worldwide. Although a large segment of the fisherman population participates on a recreational level, another significant segment of the fisherman population is involved in the food-acquiring and -producing industries in the world. Millions of tons of fish of all types are caught and processed annually to feed a large portion of the world's population. Regardless of the reason for fishing, people of all ages enjoy doing so in streams, lakes, and other bodies of water as the climate and season of the year permit.

The fisherman is perhaps one of the most diversely equipped of all outdoor sportsmen. The basic items needed to catch a fish may only include a hook, a line, a sinker, and bait or a lure. Thus equipped with only the minimum amount a gear, one might find a fisherman with a bamboo pole, a length of line, and a baited hook. But, for many fishermen, desired equipment goes far beyond that simple array. The skilled, experienced angler has a variety of fishing rods, reels, line types, hooks, floats, and artificial lures. These are generally secured in portable containers for protection and ease of access.

As described in U.S. Pat. No. 4,970,982 to Martin, in bass tournaments and other fishing tournaments, it is a common requirement that the fish that are caught must be maintained in a live condition and released back into the lake or other body of water at the end of the tournament. Because of this and also to permit fish to be caught and kept alive in good physical condition for extended periods, some boats are provided with built-in livewells. The livewell is essentially a water tank in the boat that is large enough to hold the fish that are caught. Typically, water is circulated in the livewell by drawing water from its bottom portion and spraying water back in at the top above the water. Spraying the water through the air above the water level aerates the water so that air is made available to the fish in the livewell.

In fact, most people who fish for sport practice this catch and release rule. This involves returning the fish to its natural environment. This policy is supported by various sport fishing associations, particularly during fishing tournaments. The intent of this type of action is to help maintain healthy fishing grounds for the future.

Fishing contests are popular with catch and release anglers. Fish are caught, placed in the livewell on the boat and brought to a weighing station. Sometimes, the wait at this station is long, placing the fish in peril of their lives. So, while the fish are kept alive in the livewell on the boat, the time between removing the fish from the livewell, going to the weight station, and returning the fish to their environment is often too long for the fish to endure and the fish end up dying despite the anglers' best efforts.

Thus, there remains a need for a means to keep the fish alive by providing aerated water to the gills of the fish during these periods of time. The present invention is directed to filling this need in the art.

### SUMMARY OF THE INVENTION

The present invention addresses these and other needs and drawbacks of the art by providing a means by which fish are kept alive for an extended time after being caught and brought to a weighing station or other out of water location. The portable livewell of this invention comprises a lined bag providing a volume adequate to carry a fish of an anticipated size and weight and a system for aerating a quantity of water within the lined bag. Preferably, the bag retains a quantity of the water from which the fish was harvested while being moved. This allows the fish to be returned to its environment in relatively good health. The water is circulated by a self-contained aeration system, including a battery-powered pump.

The portable livewell of this invention is simple to manufacture and to use. It is constructed of a number of interrelated components. These components preferably include a plastic bag-like container with an attached handle, preferably of nylon. The invention further comprises an electric pump, an aerator, plastic hoses, and connecting hardware.

The container may vary in size depending on the size of the fish to be retained within the container. The standard product model is preferably about twenty-four inches high, for example. The length and width of the container may also be twenty-four inches.

The handle attached to the top of the container may be used to carry the container. Air is pumped into the container through the aerator sealed in a pouch and placed into the container.

The invention thus provides a healthy, portable environment for fish that have been recently caught. As the fish are taken to a weigh in station or other location for a short amount of time, water from their natural habitat may be poured into the container unit. The fish are then put into the container. The aerator is sealed in a pouch and inserted into the container. Hoses allow for air to be circulated through the water within the container are connected to the aerator. With the electric pump activated, the aerator promotes a healthy temporary environment until the fish are returned to their environment.

These and other features, objects, and advantages of the present invention will be readily apparent to those of skill in the art from a review of the following detailed description along with the accompanying drawing figures.

### BRIEF DESCRIPTION OF THE DRAWINGS

So that the manner in which the above recited features, advantages and objects of the present invention are attained and can be understood in detail, more particular description of the invention, briefly summarized above, may be had by reference to embodiments thereof which are illustrated in the appended drawings.

FIG. 1 is a perspective view of the portable livewell of the present invention.

FIG. 2 is a perspective detail view of an aeration system of this invention.

### DETAILED DESCRIPTION OF A PREFERRED EMBODIMENT

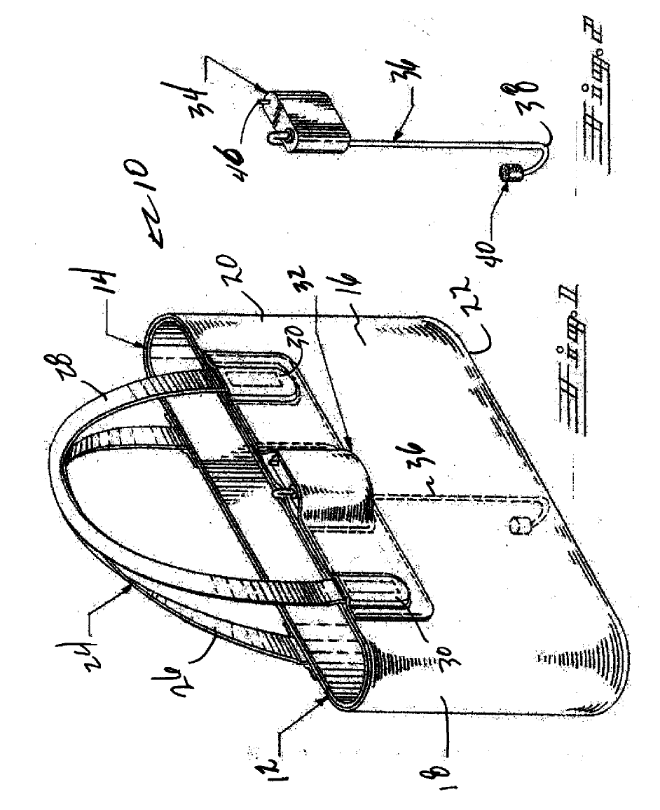

Referring now to the drawing figures, a portable livewell 10 of this invention is illustrated. The livewell 10 generally comprises an outer container or body 12 formed of a reasonably rigid material and an inner lining 14 formed of a substantially water tight material. As shown in FIG. 1, the container 12 may comprise vertical wall 16 with rounded ends 18 and 20 and a closed bottom 22.

A handle 24 comprises a pair of straps 26 and 28 for ease of carrying the livewell 10. The handle 24 may be attached to the container 12 by sewing, for example, onto a set of pedestal mounts 30 which are very durable for long, useful life of the livewell. Other carrying apparatus may be used, such as for example a shoulder strap, or even a rolling dolly to reduce the strain of carrying the device with water and a fish retained within.

Also attached to the container 12 is a pouch 32 to retain a battery operated pump 34. The pump 34 draws in air and pumps the air down through a tube 36. Preferably, the tube 36 is fed between the container 12 and the inner lining 14. The tube 36 terminates at its lower end with a J-tube 38 with an air stone 40 at the end of the tube. The air pump 34 also includes an air inlet 46 to provide an access to draw air into the air pump. The air stone produces bubbles which escape into the water within the inner lining 14 to aerate the water.

As previously described, the size of the livewell may vary, depending on the fish to be carried. Other variations and alterations may also be included, such as for example making the container and liner transparent to see the fish within the livewell.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

1. A portable livewell comprising:
a. a portable container adapted to retain a quantity of water, the container comprising a pair of substantially parallel walls, a pair of opposing ends, and a bottom, the walls the ends defining an upper edge, the container further comprising an outer body and an inner liner;
b. a handle attached to the container at the upper edge; and
c. an aeration system to aerate the water within the container, the aeration system comprising:
i. a battery operated air pump;
ii. an air inlet into the air pump; and
iii. a tube extending between the outer body and the inner liner to direct air from the pump into the water within the container.

2. (canceled)

3. The livewell of claim 2, wherein the handle comprises a pair of straps.

4. The livewell of claim 2, wherein the handle comprises a shoulder strap.

5. (canceled)

6. The livewell of claim 1, wherein the tube terminates in a J-tube.

7. The livewell of claim 1, wherein the tube defines an end and further comprising a means for producing air bubbles on the end of the tube.

8. The livewell of claim 1, further comprising a pouch on the container to hold the pump.

9. The livewell of claim 1, wherein the container is made of a transparent material.

10. (canceled)

11. (canceled)

12. A portable livewell to retain a fish in a live condition, the livewell comprising:
a portable container adapted to retain a quantity of water, the container comprising an outer body and an inner lining, the outer body defining an upper edge;
a handle attached to the outer body at the upper edge; and
an aeration system to aerate the water within the container, the aeration system comprising:
a battery operated air pump;
an air inlet into the air pump; and
a tube to direct air from the pump into the water within the container; and
wherein the tube is positioned between the outer body and the inner liner.

13. (canceled)

14. The livewell of claim 12, wherein the handle comprises a pair of straps.

15. The livewell of claim 12, wherein the handle comprises a shoulder strap.

16. The livewell of claim 15, wherein the tube terminates in a J-tube.

17. The livewell of claim 15, wherein the tube defines and end and further comprising a means for producing air bubbles on the end of the tube.

18. The livewell of claim 15, further comprising a pouch on the container to hold the pump.
